(19) United States
(12) Patent Application Publication
(10) Pub. No.: US 2023/0113788 A1
(43) Pub. Date: Apr. 13, 2023

(54) SYSTEM BASED ON LEARNING PEPTIDE PROPERTIES FOR PREDICTING SPECTRAL PROFILE OF PEPTIDE-PRODUCING IONS IN LIQUID CHROMATOGRAPH-MASS SPECTROMETRY

(71) Applicant: BERTIS INC, Seongnam-si, Gyeonggi-do (KR)

(72) Inventors: Hyeon Seok SHIN, Yongin-si (KR); Sung Soo KIM, Yongin-si (KR)

(73) Assignee: BERTIS INC, Seongnam-si, Gyeonggi-do (KR)

(21) Appl. No.: 17/907,793

(22) PCT Filed: Feb. 26, 2021
(86) PCT No.: PCT/KR2021/002477

§ 371 Date: Aug. 29, 2022

(30) Foreign Application Priority Data
Feb. 28, 2020 (KR) 10-2020-0024713

(51) Int. Cl. G06N 5/04

(52) U.S. Cl. CPC G06N 5/04

(57) ABSTRACT

The present invention provides a system for predicting the spectral profile of a peptide, wherein the spectrum of a sample to be checked can be efficiently analyzed by machine learning properties of the peptide and generating training data for predicting the spectral profile.

### TECHNICAL FIELD

The present disclosure relates to a system for predicting a spectral profile of peptide product ions using a liquid chromatograph-mass spectrometry (LC-MS) based on peptide characteristic learning, and a method using the same, and more particularly, to a method of interpreting a peak of a peptide product ion spectrum.

### BACKGROUND ART

A peptide quantification method using the LC-MS mainly quantifies a peptide fragment, that is, a peak chromatogram including a fragment having the highest peak among produced ions. Among the peptide fragmentation methods, collision-induced dissociation (CID) is widely used in a triple-quadruple mass spectrometry instruments, is a method of fragmenting ionized peptides by the physical impact of nitrogen gas, and separates them from substances with the same retention time (RT). Meanwhile, Korean Patent No. 10-2020-0143551 discloses a step of modeling a quantitative structure-retention relationship (QSRR) equation; and a method of predicting chromatographic elution sequence of a compound in a mixture from the QSRR equation using a mathematical programming, but does not include a peptide fragmentation method.

In many cases, expensive standard heavy peptides are used to distinguish the peptides by the LC-MS/MS. Therefore, in order to solve such a problem, inventors of the present disclosure could increase the number of proteins that may be measured when executing multiple reaction monitoring (MRM) once and distinguish a peak of a peptide from peaks of other peptides that are causes of noise, that is, have similar and overlapping retention time (RT) and mass charge ratio (M/Z) values by predicting all patterns or profiles in which the peptide is fragmented.

### DISCLOSURE

### Technical Problem

An aspect of the present disclosure provides a system for predicting a spectral profile of a peptide capable of efficiently performing analysis of a spectrum of a sample to be confirmed by machine-learning characteristics of the peptide to generate learning data for predicting a spectral profile.

### Technical Solution

In an embodiment, a system for predicting a spectral profile of a peptide includes: a data acquisition unit acquiring sequences of a plurality of learning peptides and spectral data corresponding to the plurality of learning peptides;

a machine learning unit including a plurality of learning models that are predetermined, extracting a plurality of characteristics of sequences of the plurality of learning peptides, performing learning using the plurality of characteristics and a spectrum corresponding to the plurality of learning peptides as respective input values of the plurality of learning models, and acquiring peptide analysis learning data output from the plurality of learning models; and

a peak prediction unit predicting a spectral profile of spectral data corresponding to a peptide to be confirmed using the peptide analysis learning data.

The machine learning unit may include a first learning model performing learning using amino acid sequence type information included in the learning peptide as an input value. The first learning model may be implemented as a recurrent neural network (RNN). The machine learning unit may include a second learning model performing learning using charges, a mass, and a length of the unit peptide, and the presence or absence of proline in the unit peptide as an input value. The second learning model may be implemented as at least one fully connected layer. The machine learning unit may include a third learning model performing learning using fragmentation information corresponding to the two or more unit peptides as an input value. The third learning model may be implemented as a convolution neural network (CNN). The machine learning unit may predict a fragment sequence of the plurality of peptide product ions corresponding to each of a C direction and an N direction based on a position where the fragmentation of the unit peptide starts. The machine learning unit may acquire the peptide analysis learning data by giving a predetermined weight to each of the plurality of learning models.

The peak prediction unit may determine the spectral profile corresponding to the peptide to be confirmed.

In an embodiment, a system for predicting a spectral profile of a peptide includes: a data acquisition unit acquiring sequences of a plurality of learning peptides and spectral data corresponding to the plurality of learning peptides; and

a machine learning unit including a plurality of learning models that are predetermined, extracting a plurality of characteristics of sequences of the plurality of learning peptides, performing learning using the plurality of characteristics and a spectrum corresponding to the plurality of learning peptides as respective input values of the plurality of learning models, and acquiring peptide analysis learning data output from the plurality of learning models;

wherein the machine learning unit additionally performs learning by comparing a predicted spectrum and an actually measured spectrum with each other.

The machine learning unit may include a first learning model performing learning using amino acid sequence type information included in the learning peptide as an input value; a second learning model performing learning using charges, a mass, and a length of the unit peptide, and the presence or absence of proline in the unit peptide as an input value; and a third learning model performing learning using fragmentation information corresponding to the two or more unit peptides as an input value.

In an embodiment, each learning model may learn data for predicting a peak in LC-MS of a specific peptide using a plurality of learning peptides. In the present disclosure, the LC-MS may refer to liquid chromatography-mass spectrometry (LC-MS), liquid chromatography-mass spectrometry/mass spectrometry (LC-MS/MS), and may refer to an analysis system using mass-spectrometry (MS) in a detection unit of liquid chromatography (LC). In the present disclosure, a multiple reaction monitoring (MRM) method using mass-spectrometry (MS) is an analysis technique capable of monitoring a change in their concentration by selectively separating, detecting, and quantifying specific analytes. In the present disclosure, the mass spectrometry is a method of measuring mass-to-charge ratios of ionized molecules, and the accelerated ions may selectively pass through an electric or magnetic field suitable for the mass-to-charge ratio. In addition, another mass spectrometry in an embodiment may transmit energy to a system where molecules with different mass-to-charge ratios are filtered out and only the desired molecule predicts the spectral pattern of the peptide, and visualize the chromatogram peak with the intensity of the electronic signal to determine a concentration of a molecule. The mass spectrometry of the present disclosure may be SRM or MRM, but is not limited thereto.

In an embodiment, the MRM may refer to a method capable of quantitatively and accurately measuring multiple substances, such as trace amounts of biomarkers, present in a biological sample. The MRM is used for quantitative analysis of small molecules and is used to diagnose specific diseases. The MRM method has the advantage that it is easy to measure multiple peptides at the same time, and it is possible to confirm a relative concentration difference of protein diagnostic marker candidates between normal people and patients with cancers without antibodies. In addition, the MRM analysis methods have been introduced to fragment a complex protein in the blood into peptides, select a peptide that may represent a specific protein, and simultaneously analyze a number of selected peptides, in particular, in proteomic analysis using mass spectrometry, due to its excellent sensitivity and selectivity.

In an embodiment, the present disclosure is applicable to mass spectrometers using collision-induced dissociation. In the present disclosure, collision-induced dissociation (CID), also called collisionally activated dissociation (CAD), may refer to a mechanism in which gaseous molecular ions are generated during mass spectrometry. In mass spectrometry, CD may refer to a mechanism that fragments molecular ions in a gaseous phase. Molecular ions are usually accelerated by some electric potential to have high kinetic energy and collide with neutral molecules (often helium, nitrogen, argon). In the collision, some of the kinetic energy is converted to internal energy and causes the breakage of bonds, making molecular ions into small pieces. These ion fragments may be analyzed using a mass spectrometer. In the present specification, the learning peptide may refer to any material, biological fluid, tissue, or cell obtained from or derived from an individual for learning.

In the present disclosure, the term “biological sample” refers to any material, biological fluid, tissue, or cell obtained from or derived from an individual. An example thereof may includes whole blood, leukocytes, peripheral blood mononuclear cells, buffy coat, plasma, serum, sputum, tears, mucus, nasal washes, nasal aspirate, breath, urine, semen, saliva, peritoneal washings, ascites, cystic fluid, meningeal fluid, amniotic fluid, glandular fluid, pancreatic fluid, lymph fluid, pleural fluid, nipple aspirate, bronchial aspirate, synovial fluid, joint aspirate, organ secretions, cell, cell extract, or cerebrospinal fluid, but preferably, a liquid biopsy collected for histopathological examination by inserting a hollow needle, etc. into an in vivo organ without incision of the skin of a patient with high risk of disease (e.g., the patient's tissue, cells, blood, serum, plasma, saliva, sputum, ascites, etc.).

In the present disclosure, the term “peptide” is a polymer in which amino acid units are artificially or naturally linked. A function of the peptide varies depending on the combination of amino acids, and each amino acid is linked by a covalent bond called a peptide bond. The peptide bond is a chemical bond in which a covalent bond of an amide bond (—CO—NH—) is formed between a carboxyl group (—COOH) and an amino group (NH2-) of an amino acid. A dehydration reaction occurs in which water molecules are formed during the reaction. Through this process, the peptide has an N-terminal (amino-terminal) having an amino group and a C-terminal (carboxyl-terminal) having a carboxyl group, which indicates the directionality of the peptide. In the present disclosure, the peptide is ionized in tandem mass-spectrometry (MS) to have a unique mass-to-charge ratio (m/z) value, and is fragmented into peptide fragment through collision-activated dissociation, and fragmented peptide ions are called product ions. Here, unique “fragmentation” information according to the characteristics of the peptide, that is, information on the product ions may be obtained. Meanwhile, a peptide ion before fragmentation into a peptide fragment is called a “precursor ion.”

The phrase “amino acid or peptide characteristics or characteristic information” of the present disclosure is information such as, but not limited to, a type of amino acid peptide sequence, collision energy (CE), charge amount, sequence length, ionization degree, hydrophilicity, number of prolines, and fragmentation information, and is a unique value of a specific amino acid peptide.

In an embodiment of the present disclosure, the LC-MS refers to liquid chromatography-mass spectrometry (LC-MS), liquid chromatography-mass spectrometry/mass spectrometry (LC-MS/MS), and refers to an analysis system using mass-spectrometry (MS) in a detection unit of liquid chromatography.

In an embodiment of the present disclosure, the mass spectrometry has a principle that molecules having a specific mass-to-charge ratio are quantified as a collision energy generated by the collision at the detector is converted into electrical energy, through a selective electromagnetic field that matches the mass-to-charge ratio of ionized molecules or atoms from the sample. The mass spectrometry of the present disclosure may be SRM or MRM, but is not limited thereto. In the present disclosure, a multiple reaction monitoring (MRM) method using mass-spectrometry (MS) is an analysis technique capable of monitoring a change in their concentration by selectively separating, detecting, and quantifying specific analytes. The MRM is a method that may quantitatively and accurately measure multiple substances, such as trace amounts of biomarkers, present in a biological sample, and selects specific ions (referred to as mother ions or precursor ions) using a first mass filter Q1, but selectively delivers the selected ions to a collision tube for more accurate measurement. Then, the mother ions arriving at the colliding tube collide with an internal colliding gas in a second mass filter (Q2), are split to generate product ions (or daughter ions), and are sent to a third mass filter (Q3), where only ions corresponding to specific m/z values of several generated ions are transmitted to the detector. The MRM is an analytical method with high selectivity and sensitivity that may detect only the information of the desired component in this way. The MRM method has the advantage that it is easy to measure multiple peptides at the same time, and it is possible to confirm a relative concentration difference of protein diagnostic marker candidates between normal people and patients with cancers without antibodies. In addition, the MRM analysis method has been introduced for the analysis of complex proteins and peptides in blood, in particular, in proteome analysis using mass spectrometry due to its excellent sensitivity and selectivity (see Anderson L. et al., Mol Cell Proteomics, 5:375-88, 2006; DeSouza, L. V. et al., Anal. Chem., 81:3462-70, 2009).

In an embodiment of the present disclosure, the probability or intensity for fragmentation is calculated in fragmentation units of four amino acids.

In an embodiment of the present disclosure, as shown in Table 1 below, the prediction of total charge, hydrophobicity, mass, M/Z and Y fragmentation may be calculated as follows, but is not limited thereto.

TABLE 1
Net charge

| [symbol] → [symbol] | | | | | | | | | |
|---|---|---|---|---|---|---|---|---|---|
| | [symbol] | [symbol] | [symbol] | [symbol] | [symbol] | [symbol] | [symbol] | [symbol] | |
| [symbol] [symbol] [symbol] [symbol] | [symbol] [symbol] [symbol] [symbol] | [symbol] [symbol] [symbol] [symbol] | [symbol] [symbol] [symbol] [symbol] | [symbol] [symbol] [symbol] [symbol] | [symbol] [symbol] [symbol] [symbol] | [symbol] [symbol] [symbol] [symbol] | [symbol] [symbol] [symbol] [symbol] | [symbol] [symbol] [symbol] [symbol] | $\begin{matrix}Net charge equation \\ Z = \text{?} \text{?} \frac{\text{?}}{\text{?} + \text{?}} - \text{?} \text{?} \frac{\text{?}}{\text{?} + \text{?}}\end{matrix}$ |

| | |
|---|---|
| Hydrophobicity | Mass |
| [symbol] | Net mass: h + \|Sum of peptide mass\| + Oh + h |
| [symbol] | M/Z |
| [symbol] | (Net mass/net charge) + 1/2 hydrogen |
| [symbol] | |
| Therefore, hydrophobicity was calculated as: | Y-fragment prediction |
| [symbol] and [symbol] [symbol] [symbol] | $ln ( \frac{{y}_{i}}{\text{?}} ) = β [ \text{?} Δ E ( \text{?} - 1 ) + Δ E ( TN , 1 - \text{?} ) + Δ E ( TC , n - i ) ]$ |

[symbol]

indicates data missing or illegible when filed

### Advantageous Effects

A system of predicting a spectral profile of a peptide according to an embodiment may efficiently perform analysis of a spectrum of a sample to be confirmed by machine-learning a peptide and a spectrum of the peptide to generate learning data for predicting a spectral profile.

The system of predicting a spectral profile of a peptide according to an embodiment may easily grasp noise hindering peak analysis.

### DESCRIPTION OF DRAWINGS

FIG. 1 is a block diagram illustrating a system of predicting a spectral profile of a peptide according to an embodiment.

FIG. 2 is a diagram schematically illustrating a fragment sequence of the peptide according to an embodiment.

FIGS. 3 to 5 are diagrams illustrating interrelationship between the fragment sequences of the peptides.

FIG. 6 is a diagram for explaining an operation of predicting a spectrum and a spectral profile of a peptide to be confirmed according to an embodiment.

FIG. 7 is a diagram for explaining an operation of generating learning data by a system for predicting a spectral profile of a peptide according to an embodiment.

FIG. 8 is a flowchart of the present disclosure according to an embodiment.

### BEST MODE

A system of predicting a spectral profile of a peptide according to an embodiment may efficiently perform analysis of a spectrum of a sample to be confirmed by machine-learning a peptide and a spectrum of the peptide to generate learning data for predicting a spectral profile.

The system of predicting a spectral profile of a peptide according to an embodiment may easily grasp noise hindering peak analysis.

### Mode for Disclosure

Hereinafter, various embodiments disclosed herein will be described with reference to the drawings. In the following description, various specific details such as specific forms, compositions and processes, and the like, will be described for a thorough understanding of the present disclosure. However, specific embodiments may be practiced without one or more of these specific details or together with other known methods and forms. In another example, well-known processes and manufacturing technologies have not been described as specific details in order not to unnecessarily obscure the present disclosure. Reference to “one embodiment” or “an embodiment” throughout the present specification means that particular features, forms, compositions, or characteristics described in conjunction with an embodiment are included in one or more embodiments of the disclosure Accordingly, references to “in one embodiment” or “an embodiment” at various positions throughout the present specification do not necessarily refer to the same embodiment of the disclosure. Additionally, the particular features, forms, compositions, or characteristics may be combined with each other in any suitable way in one or more embodiments. Accordingly, it is to be understood that there may be various modifications that may be substituted for one or more embodiments at the time of filing the present application.

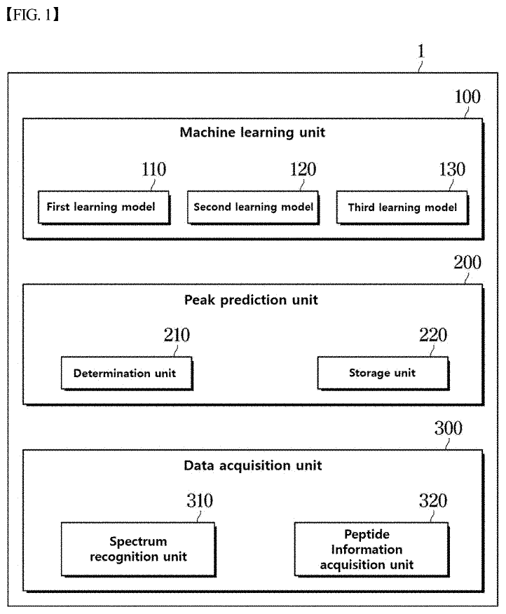

FIG. 1 is a block diagram illustrating a system 1 of predicting a spectral profile of a peptide according to an embodiment. Referring to FIG. 1, the system 1 of predicting a spectral profile of a peptide according to an embodiment may include a machine learning unit 100, a peak prediction unit 200, and a data acquisition unit 300. The machine learning unit 100 may include a first learning model 110, a second learning model 120, and a third learning model 130. Meanwhile, in an embodiment of the present disclosure, the machine learning unit 100 may include a plurality of learning models that are predetermined.

It has been illustrated in FIG. 1 that the machine learning unit 100 includes the first learning model 110, the second learning model 120, and the third learning model 130. The machine learning unit 100 may receive a plurality of characteristics of a plurality of learning peptide sequences transferred from the data acquisition unit 300. The plurality of characteristics may refer to a one-hot encoded sequence, collision energy (CE), charges, a length, the presence or absence of amino acid proline, and a relationship between peptide fragment sequences. The one-hot encoded sequence is determined by giving numerals according to types of amino acid. For example, it may refer to a vector expression manner of a word that uses the types of amino acid as a dimension of a vector, gives a value of 1 to an index of a word to be expressed, and gives 0 to another index, but is not limited thereto.

Meanwhile, the first learning model 110 may perform learning using information on the type of amino acid sequence included in the learning peptide as an input value. This first learning model 110 may be implemented as a recurrent neural network (RNN). The recurrent neural network (RNN) is a type of artificial neural network, and may include a feature in which connections between units have a cyclic structure.

Meanwhile, the second learning model 120 may learn charges, a mass, and a length of the unit peptide and present of absence of proline in the unit peptide as an input value. This second learning model 120 may be implemented as a fully connected layer. The fully connected layer is a part of a layer constituting a CNN to be described later, and may refer to a layer that arrives at a classification decision by taking a final result of a network process.

The third learning model 130 may input information on the fragmentation possibility of a unit peptide composed of two or more sequences. Here, the fragment sequence is divided into a fragment on an N-terminal side and a fragment on a C-terminal side of the peptide. In the present disclosure, y-site refers to an amino acid at a position where fragmentation occurs, and in the y-site, the N direction may be expressed as − and the C direction as +. The third learning model 130 may perform learning using the relationship between the plurality of fragment sequences as an input value. This third learning model 130 may be implemented as a convolution neural network (CNN). The convolutional neural network (CNN) may refer to a type of multi-layer, feed-forward artificial neural network used to analyze data.

Meanwhile, the machine learning unit 100 may acquire peptide analysis learning data using the above-mentioned learning model. The machine learning unit 100 may acquire the peptide analysis learning data by giving a predetermined weight to each of the learning models. The predetermined weight may refer to a weight having a smaller loss as an error for a high peak is smaller to make it easier to predict a spectral profile. Such a weight may use a pearson correlation coefficient (PCC), which is easy to compare values with different ratios to evaluate the accuracy.

PCC may be applied as shown in Table 1 below.

TABLE 2

| | Pearson correlation | Expected |
|---|---|---|
| | coefficient between | accuracy |
| | predicted values and | of spectral |
| Classification | correct values | profile |
| Algorithm | 0.842 | 67.764% |
| by first | | |
| learning model | | |
| Algorithm | 0.986 | 72.551% |
| by second | | |
| learning model | | |
| Algorithm | 0.987 | 74.477% |
| by third | | |
| learning model | | |

The above-described description is only an embodiment to which the PCC is applied, and there is no limitation on the operation of improving the accuracy of peak prediction. Meanwhile, the peak prediction unit 200 may predict the spectral profile of the spectral data of the peptide to be confirmed using the peptide analysis learning data. The peptide to be confirmed may refer to a peptide that is an object of spectral profile prediction. The peak prediction unit may include a storage unit 220 for storing the above-described peptide analysis learning data and a determination unit 210 for performing peak prediction based on the peptide learning data. The peak prediction unit 200 may calculate the number of all cases in which fragmentation is possible from a peptide and predict a peak profile with the highest probability among them. A detailed operation of the peak prediction unit 200 predicting the peak of the peptide to be confirmed based on the data derived by the above-described machine learning unit will be described below.

Meanwhile, a data acquisition unit 300 may acquire the above-described plurality of learning peptide sequences and spectral data corresponding to the plurality of learning peptides. The data acquisition unit 300 may include a peptide information acquisition unit 320 that acquires information such as charges, a length, and the presence or absence of amino acid proline, and a spectrum recognition unit 310 that acquires spectrum information of the corresponding peptide. The spectrum recognition unit 310 may be implemented as a liquid chromatography apparatus, etc. The peptide information acquisition unit 320 may be provided with a mass spectrometer and a protein electrophoresis device, etc., but there is no limitation in the device configuration corresponding to each configuration.

Meanwhile, the machine learning unit 100, the peak prediction unit 200, and the data acquisition unit 300 may be implemented as an algorithm for controlling the operation of components in the system 1 for predicting a spectral profile of a peptide, or a memory (not shown) storing data for a program in which the algorithm is reproduced, and a processor (not shown) that performs the above-mentioned operation using data stored in the memory. In this case, the memory and the processor may be implemented as separate chips. Alternatively, the memory and the processor may also be implemented as a single chip.

At least one component may be added or deleted in response to the performance of the components of the system 1 for predicting the spectral profile of the peptide illustrated in FIG. 1 In addition, it will be readily understood by those of ordinary skill in the art that the mutual positions of the components may be changed corresponding to the performance or structure of the system.

Meanwhile, each component illustrated in FIG. 1 refers to a hardware component such as software and/or a field programmable gate array (FPGA) and an application specific integrated circuit (ASIC).

FIG. 2 is a diagram schematically illustrating a fragment sequence of a peptide according to an embodiment.

FIG. 2 illustrates that the peptide (P2) is fragmented into a peptide (P211) provide with “VCATTSL” and a peptide (P212) provided with “GVEDPLK”, respectively. Meanwhile, the amino acid of “L” may be located at the end of the peptide (51) of P211, and the amino acid of “G” may be located at the end of the peptide of P22 (S2). The peptides and amino acids constituting the peptides illustrated in FIG. 2 are merely examples for explaining the contents of the present disclosure, which will be described later, and there is no limitation on the composition of the peptides.

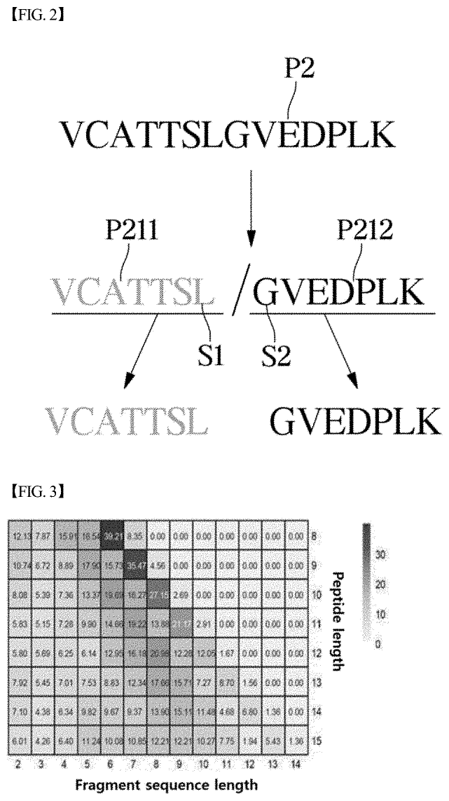

FIGS. 3 to 5 are diagrams illustrating interrelationship between the fragment sequences of the peptides.

FIG. 3 illustrates the correlation between the length of the fragment sequence in which the peptide described in FIG. 2 is fragmented and the length of the peptide as predicted values.

The machine learning unit 100 may calculate a fragmentation probability for a combination of amino acids included in the peptide.

FIG. 3 illustrates the length of the fragment sequence in which the peptide is fragmented and the fragmentation probability corresponding to the length of the peptide.

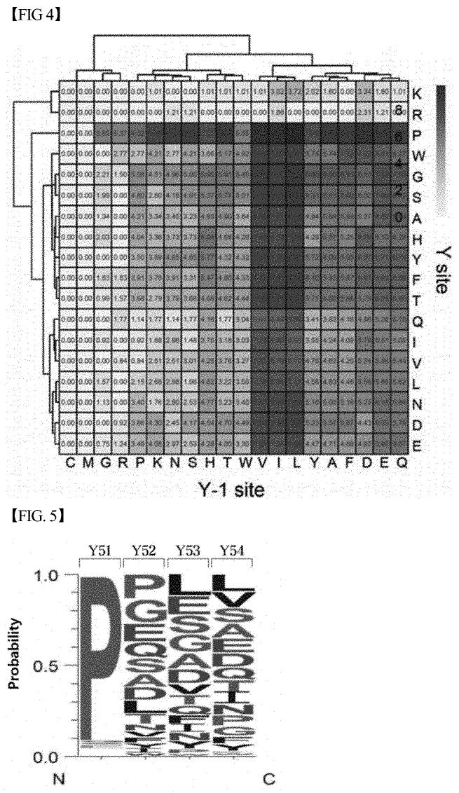

Meanwhile, FIG. 4 is a diagram illustrating a peptide fragmentation pattern by a pattern of y-site and y−1 site.

In the present disclosure, the peptide fragment may be classified into an N-terminal fragment and a C-terminal fragment.

In the present disclosure, the y-site refers to an amino acid at a position where the fragmentation occurs, and in the y-site, the N direction may be expressed as − and the C direction as +.

Referring to both FIGS. 2 and 4, the terminal S1 in P211 is provided with “L”, and the corresponding amino acid corresponds to the C-terminal of the peptide and may correspond to the y−1 site.

Meanwhile, the terminal S2 in P212 is provided with “G”, and the corresponding amino acid corresponds to the N-terminal of the peptide and may correspond to they site. The predicted value between the amino acids corresponding to the y-site and the y−1 site may be expressed as illustrated in FIG. 4 Meanwhile, as described above, the machine learning unit 100 may calculate by synthesizing probabilities and characteristics such as an N-term sequence, a C-term sequence, a peptide length, an amino acid sequence, etc. The machine learning unit 100 may learn the importance of various characteristics using machine learning and deep learning techniques. Meanwhile, the machine learning unit 100 may automatically repeat machine learning until prediction accuracy is saturated using machine learning and deep learning techniques

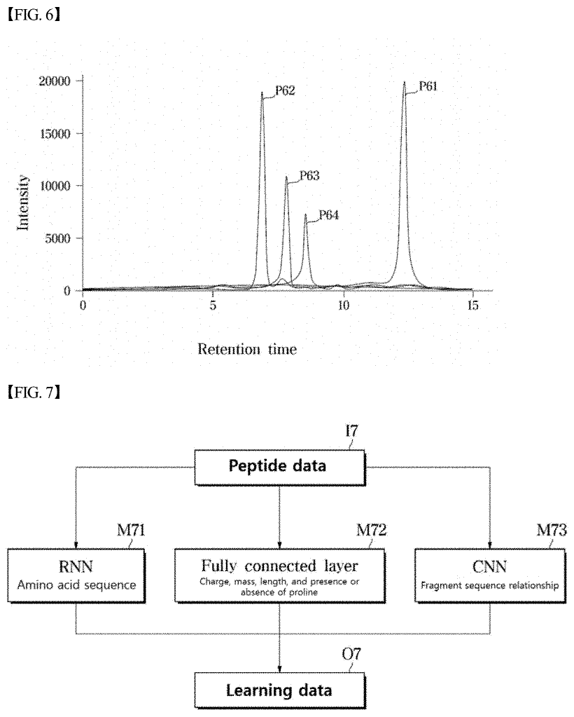

FIG. 5 presents an example illustrating the distribution of amino acids at positions y-site, y-site+1, y-site+2, and y-site+3 when the charge of the Y-site precursor is 2 and the charge of the fragment sequence is also 2. Referring to FIG. 5, FIG. 5 illustrates an embodiment when the charge of the precursor is 2. In the fragment sequence of the peptide, the y-site may be provided with an amino acid corresponding to y51. In the fragment sequence of the peptide, the y+1-site may be provided with an amino acid corresponding to y52. In the fragment sequence of the peptide, the y+2-site may be provided with an amino acid corresponding to y53. In the fragment sequence of the peptide, the y+3-site may be provided with an amino acid corresponding to y54.

Meanwhile, the contents presented in FIGS. 2 to 5 are only an example of the amino acid sequence used for learning by the system for predicting a spectral profile of the peptide of the peptide sequence, so there is no limitation on the type of amino acid sequence used by the system for predicting a spectral profile of the peptide.

The machine learning unit may also learn the relationship between the fragment sequences and may be used to predict the spectral peak of the peptide to be confirmed.

FIG. 6 is a diagram for explaining an operation of predicting a spectrum and a spectral profile of a peptide to be confirmed according to an embodiment, and FIG. 7 is a diagram for explaining an operation of generating learning data by a system for predicting a spectral profile of a peptide according to an embodiment.

Referring to both FIGS. 6 and 7, the system 1 for predicting a spectral profile of a peptide may acquire peptide data of a learning object (I7).

Among the peptide data obtained in this way, data corresponding to the amino acid sequence may be learned using the RNN in the first learning model (M71).

In addition, the second learning model may perform machine learning based on charges, a length of the peptide, and the presence or absence of the amino acid praline, etc. (M72).

In addition, the third learning model may learn the relationship with the above-described fragment sequence of the peptide through CNN (M73).

In addition, since an unlearned sequence is expected to be input in the machine learning illustrated in FIG. 7, a combination in which a sequence is cut by a sliding window method, rather than an already calculated value, may be used.

The sliding window is one of the methods for controlling the flow of packets between two network hosts, and may mean a method of transmitting all data included in the ‘window’ and then transmitting the next data by sliding the window to the side as soon as the transmission of the packets is confirmed. Therefore, it may be converted into three different types of input values from the input amino acid sequence and used as input values for each learning model.

Meanwhile, the learning model may use different characteristics and numerical values as input values and may change the weight corresponding to each numerical value.

According to an embodiment, although not limited thereto, the values that have passed through the layers of each learning model may be expressed and output as ratio values for the final 42 patterns. The 42 output values may include charge values 1 to 3 of the 14 fragment sequences to be fragmented, assuming that the maximum length of the input sequence is 15 or less.

Among these, the lower value shows a number close to 0, a value that cannot exist predicts a number close to −1, and the value of the highest peak may be output as a number close to 1. In this case, a value that cannot exist may be output as a value close to −1.

Through such machine learning, the machine learning unit may output the learning data O7.

The learning model used by the machine learning unit 100 in the present disclosure may include an attention mechanism, a drop layer, etc. that increase the optimization ability of training a hidden layer having a memory ability.

The machine learning unit 100 may change a weight for each amino acid sequence and characteristic during the above-described learning. The machine learning unit 100 may increase learning ability of the model when data is increased or a new important characteristic is added based on such an operation. In addition, the machine learning unit 100 may use a mean square error (MSE) to reduce the error. Meanwhile, such mean square error may be changed in order to predict the spectral profile of the peptide to be confirmed, which will be described later.

According to an embodiment, a weight is given with a smaller loss as the error with respect to a high peak is smaller to make it easier to predict the spectral profile, but the weight may be updated and may not be used as necessary.

In addition, the machine learning unit 100 may be obtained by learning the correlation between the sequence information and characteristic information of the learning peptide and the fragment sequence of the peptide, and may increase the accuracy by using a plurality of learning models in which the weight of the loss calculation method is changed. Hereinafter, an operation of predicting a peak of a peptide to be confirmed using the learning data formed based on the above-described operation will be described.

Referring to FIG. 6, FIG. 6 is a diagram illustrating the results of analyzing a substance to be confirmed by MRM chromatography. FIG. 6 is a graph illustrating the intensity of a spectrum corresponding to a retention time. The peak prediction unit 200 may predict the peak of the peptide to be confirmed using the leaning data derived based on the above-described operation. If there are a large number of peaks in such a spectrum, it is difficult to determine the pattern of the peaks for the peptide to be confirmed. Referring to FIG. 6, since a plurality of peaks including P62, P63, P64, and P61 are present in the spectrum, it is difficult to determine a spectral profile of the peptide to be confirmed through a simple operation.

Here, the peak prediction unit 200 may predict a spectral profile corresponding to the peptide to be confirmed based on the sequence of the peptide to be confirmed using the learning data O7 obtained based on the above-described operation. The spectral profile may refer to one of the peaks displayed in MRM chromatography corresponding to the peptide. The peak prediction unit 200 may calculate the number of all cases in which fragmentation is possible from the peptide and predict the peak corresponding to the most probability among them in a spectral profile.

According to an embodiment, the peak prediction unit 200 may predict the spectral profile of the corresponding peptide to be confirmed as P61. The peak prediction unit 200 predicts the pattern of the peak, selects a peptide to be confirmed, and among them predicts a fragment sequence having a spectral profile, and such a result may be used for MRM quantification technique.

In this operation, as shown in FIG. 6, when the peak prediction unit 200 predicts a peak, it is possible to increase the analysis efficiency by increasing the number of target peptides that may be used for MRM liquid biopsy by calculating the spectral profile of the peptide and a second peak as well.

Meanwhile, the operation of predicting a learning operation and the spectral profile described with reference to FIGS. 6 and 7 is only an embodiment of the present disclosure, and the operation of learning and prediction is not limited.

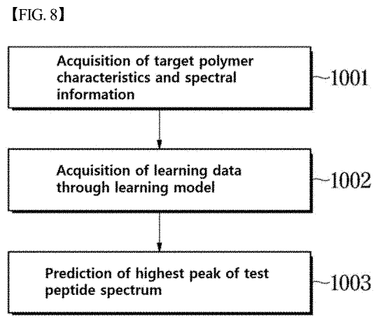

FIG. 8 is a flowchart of the present disclosure according to an embodiment.

Referring to FIG. 8, the data acquisition unit of the system for predicting a spectral profile of a peptide may acquire characteristics and spectrum information of the learning peptide (1001).

In addition, the system for predicting a spectral profile of a peptide may acquire learning data through the learning model (1002). In this operation, various machine learning methods may be used.

In addition, the system for predicting a spectral profile of a peptide may predict the spectral profile of the peptide to be confirmed by matching the sequence of the peptide to be confirmed, which is additionally obtained using the acquired learning data (1003).

Meanwhile, the disclosed embodiments may be implemented in the form of a recording medium storing instructions executable by a computer. The instructions may be stored in the form of a program code, and may perform operations of the disclosed embodiments by generating program modules when they are executed by a processor. The recording medium may be implemented as a computer-readable recording medium.

The computer-readable recording medium includes all types of recording media in which instructions readable by the computer are stored. Examples of the computer-readable recording medium may include a read only memory (ROM), a random access memory (RAM), a magnetic tape, a magnetic disk, a flash memory, an optical data storage device, and the like.

The disclosed embodiments have been described hereinabove with reference to the accompanying drawings. It will be understood by those skilled in the art to which the present disclosure pertains that the present disclosure may be practiced in forms different from those of the disclosed embodiments without changing the technical spirit or essential characteristics of the present disclosure. The disclosed embodiments are illustrative, and should not be construed as being restrictive.

### INDUSTRIAL APPLICABILITY

A system for predicting a spectral profile of a peptide according to an embodiment may efficiently perform analysis of a spectrum of a sample to be confirmed by machine-learning a peptide and a spectrum of the peptide to generate learning data for predicting a spectral profile.

The system for predicting a spectral profile of a peptide according to an embodiment may easily grasp noise hindering peak analysis.

1. A system for predicting a spectral profile of a peptide, comprising:
a data acquisition unit acquiring characteristic information of a plurality of learning peptides and spectral data corresponding to the plurality of learning peptides;
a machine learning unit including a plurality of learning models that are predetermined, extracting a plurality of characteristic information of the plurality of learning peptides, performing learning using the plurality of characteristic information and a spectrum corresponding to the plurality of learning peptides as respective input values of the plurality of learning models, and acquiring peptide analysis learning data output from the plurality of learning models; and
a peak prediction unit predicting a spectral profile of spectral data corresponding to a peptide to be confirmed using the peptide analysis leaning data when characteristic information of the peptide to be confirmed obtained from a biological sample is acquired.

2. The system for predicting a spectral profile of a peptide of claim 1, wherein the machine learning unit includes a first learning model performing learning using amino acid sequence type information included in the learning peptide as an input value.

3. The system for predicting a spectral profile of a peptide of claim 2, wherein the first learning model is implemented as a recurrent neural network (RNN).

4. The system for predicting a spectral profile of a peptide of claim 1, wherein the machine learning unit includes a second learning model performing learning using charges, a mass, and a length of a unit peptide, and the presence or absence of proline in the unit peptide as an input value.

5. The system for predicting a spectral profile of a peptide of claim 4, wherein the second learning model is implemented as at least one fully connected layer.

6. The system for predicting a spectral profile of a peptide of claim 1, wherein the machine learning unit includes a third learning model performing learning using fragmentation information corresponding to the two or more unit peptides as an input value.

7. The system for predicting a spectral profile of a peptide of claim 6, wherein the third learning model is implemented as a convolution neural network (CNN).

8. The system for predicting a spectral profile of a peptide of claim 6, wherein the machine learning unit predicts a fragment sequence of a plurality of peptide product ions corresponding to each of a C direction and an N direction based on a position where the fragmentation of the unit peptide starts.

9. The system for predicting a spectral profile of a peptide of claim 1, wherein the machine learning unit acquires the peptide analysis learning data by giving a predetermined weight to each of the plurality of learning models.

10. A system for predicting a spectral profile of a peptide, comprising:
a data acquisition unit acquiring characteristic information of a plurality of learning peptides and spectral data corresponding to the plurality of learning peptides; and
a machine learning unit including a plurality of learning models that are predetermined, extracting a plurality of characteristic information of the plurality of learning peptides, performing learning using the plurality of characteristic information and a spectrum corresponding to the plurality of learning peptides as respective input values of the plurality of learning models, and acquiring peptide analysis learning data output from the plurality of learning models,
wherein the machine learning unit additionally performs learning by comparing a predicted spectrum and an actually measured spectrum with each other.

11. The system for predicting a spectral profile of a peptide of claim 10, wherein the machine learning unit includes a first learning model performing learning using amino acid sequence type information included in the learning peptide as an input value.

12. The system for predicting a spectral profile of a peptide of claim 10, wherein the machine learning unit includes a second learning model performing learning using charges, a mass, and a length of a unit peptide, and the presence or absence of proline in the unit peptide as an input value.

13. The system for predicting a spectral profile of a peptide of claim 10, wherein the machine learning unit includes a third learning model performing learning using fragmentation information corresponding to two or more unit peptides as an input value of a sliding window manner.
